(19) United States
(12) Patent Application Publication
(10) Pub. No.: US 2009/0188846 A1
(43) Pub. Date: Jul. 30, 2009

(54) MAGNETIC WATER GENERATOR WITH VARIED POLARIZATION RATIOS

(76) Inventor: Chih-Chung Yeh, Sindian City (TW)

Correspondence Address: Chih-Chung YEH, Chung - Ho Box 8-24, Taipei, 235, TW

(21) Appl. No.: 12/019,636

(22) Filed: Jan. 25, 2008

(51) Int. Cl. C02F 1/48

(52) U.S. Cl. 210/98; 210/147

(57) ABSTRACT

A magnetic water generator with varied polarization ratios, comprises a magnetization assembly including at least one set of N pole magnetization unit and S pole magnetization unit; one side of each of the N pole magnetization unit and S pole magnetization unit having a water inlet for inputting filtering water; another side of each of the N pole magnetization unit and S pole magnetization unit having a respective water outlet; the filtered water flowing through the gaps being outputted from the water outlets to a respective transmission tube; each of the water outlets being connected with a respective transmission tube; and an electronic flow dispatching unit or a dispatching control disk for inputting water from the N pole magnetization unit and S pole magnetization unit and mixing the water with different ratios so as to have different polarization ratio.

### FIELD OF THE INVENTION

The present invention relates to water purification, and particularly to a magnetic water generator with varied polarization ratios, in that drinking water flows through a magnetization assembly for polarization with different poles (N pole and S pole) and then the water of different polarization is mixed with different ratio so as to have water suitable for human body which is helpful to the pulse and life of the users.

### BACKGROUND OF THE INVENTION

Referring to FIG. 1, Taiwan Patent No. 164275, “high magnetic activation filter magnetization assembly” discloses a magnetization assembly has a filter body 1, a cover 2 and a magnetization unit 3 which is installed in a hollow space of the body 1. Two ends of the filter body 1 are installed with respective threaded hole seats 1A for screwing the cover 2. The cover 2 is installed with a via hole 2A. A filtering net 2B is installed in the via hole 2A and is engaged by using the threads of the filtering net 2B. Water flows through the via hole and is filtered by the net 2B.

In above mentioned device, the magnetization of the water is fixed which can not be varied according to the body conditions of users. The prior art has only the function of activation, while the ratio of the polarization of the N pole and S pole can not be adjusted so that it is not sufficient to protect the health of the body of the user.

### SUMMARY OF THE INVENTION

Accordingly, the primary object of the present invention is to provide a magnetic water generator with varied polarization ratios, in that drinking water flows through a magnetization assembly for polarization with different poles and then the water of different polarization is mixed with different ratio so as to have water suitable for human body which is helpful to the pulse and life of the users.

To achieve above objects, the present invention provides magnetic water generator with varied polarization ratios, in that a magnetization assembly includes at least one set of N pole magnetization unit and S pole magnetization unit. One side of each of the N pole magnetization unit and S pole magnetization unit has a water inlet for filtering water. Another side of each of the N pole magnetization unit and S pole magnetization unit has a respective water outlet. The filtered water flowing through the gaps are outputted from the water outlets to a respective transmission tube.

Each of the water outlets is connected with a respective transmission tube.

A dispatching control disk has a tapered shape. An edge of the dispatching control disk is formed with an N pole water inlet and an S pole water inlet. An apex of the tapered dispatching control disk is formed with a common water outlet. The dispatching control disk is formed with a rotary disk. The rotary disk has eight holes of different sizes. A lower casing of the dispatching control disk has the N pole water inlet and S pole water inlet. By coupling the dispatching control disk and the lower casing of the dispatching control disk, the micro-circulation water of different polarization ratio of N magnetization and S magnetization can be derived. The magnetization assembly is formed by a stainless steel tube. The stainless steel tube is a hollow tube. An alloy toggle is installed in the tube. At least five high magnetic rare-earth permanent magnets, in that, opposite poles are faced to one another. Each space between two adjacent high magnetic rare-earth permanent magnets has a pad for isolating magnetic lines. All the high magnetic rare-earth permanent magnets are divided into two rows which are spaced by a water channel for guiding filtered water so that the water channel is retained with high magnetic field and thus the magnetic lines from the high magnetic rare-earth permanent magnets are repulsive to one another and are concentrated in the gaps therebetween. Furthermore the filtered water is magnetized by the high magnetic rare-earth permanent magnets.

The transmission tube contains nano-bamboo fibers having the functions of far infrared sterilization and deodorization. Furthermore the polarization water molecules from the water outlet of the magnetization assembly are highly pure and sweet.

An electronic flow dispatching unit comprises a circuit control module, a dual polarization flow stub, a mixing cylinder, and a water output control set. The stub is connected to the transmission tubes from the N pole magnetization unit and S pole magnetization unit. The ratio of the water from the N pole magnetization unit and S pole magnetization unit are controlled by the circuit and then the water is mixed in the mixing cylinder so as to get high magnetic water.

The various objects and advantages of the present invention will be more readily understood from the following detailed description when read in conjunction with the appended drawing.

### BRIEF DESCRIPTION OF THE DRAWINGS

FIG. 1 is an exploded schematic view of the prior art magnetization assembly.

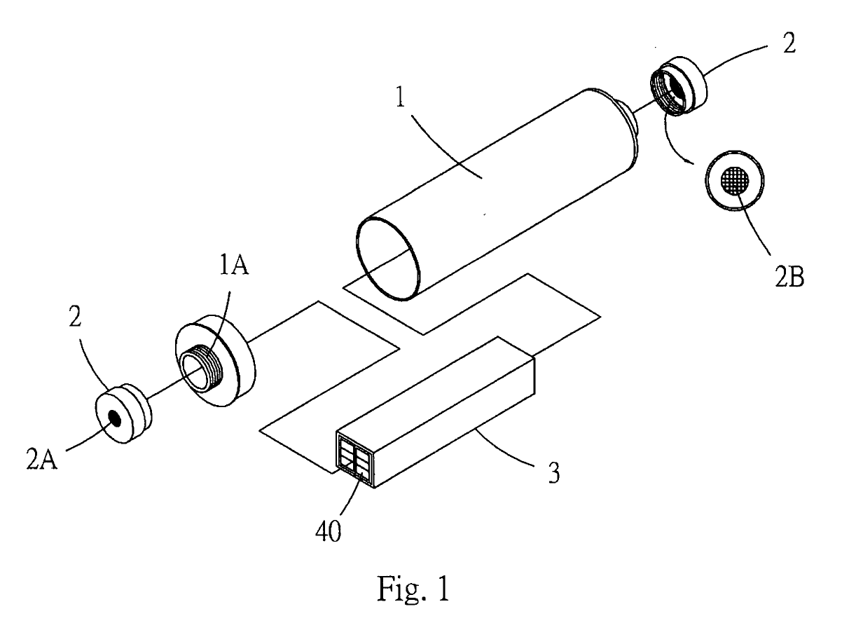

FIG. 2 is an exploded schematic view of the present invention.

FIG. 3 is a schematic perspective view of the present invention.

FIG. 4 is a schematic cross sectional view showing the interior of the present invention.

FIG. 5 shows the ratio of the hole sizes of the dispatching control disk and the rotary disk according to the present invention.

FIG. 6 is a schematic view showing that the present invention is installed with filter cores and is installed in a box.

FIG. 7 is a schematic view showing the application of the present invention.

FIG. 8 is a schematic view showing the electronic flow comparison unit of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

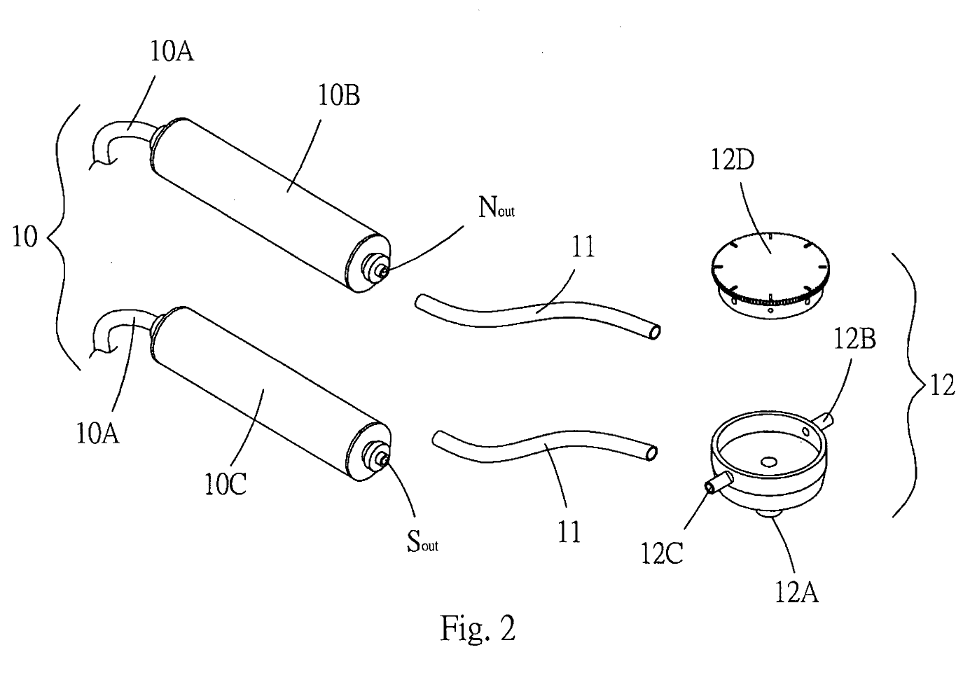

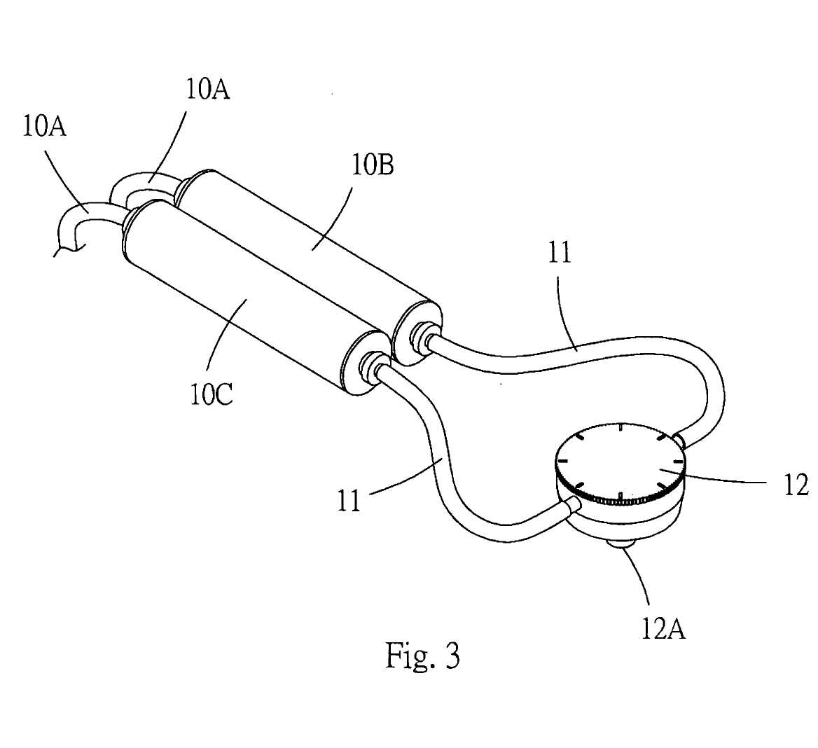

Referring to FIGS. 2 and 3, the micro-circulation water sequentializing device comprises the following elements.

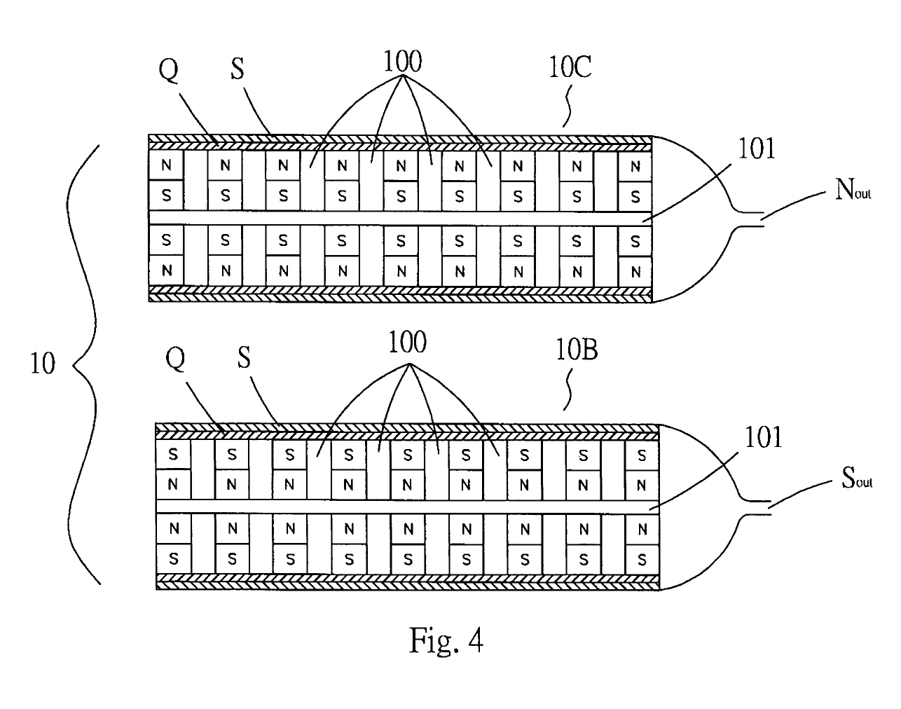

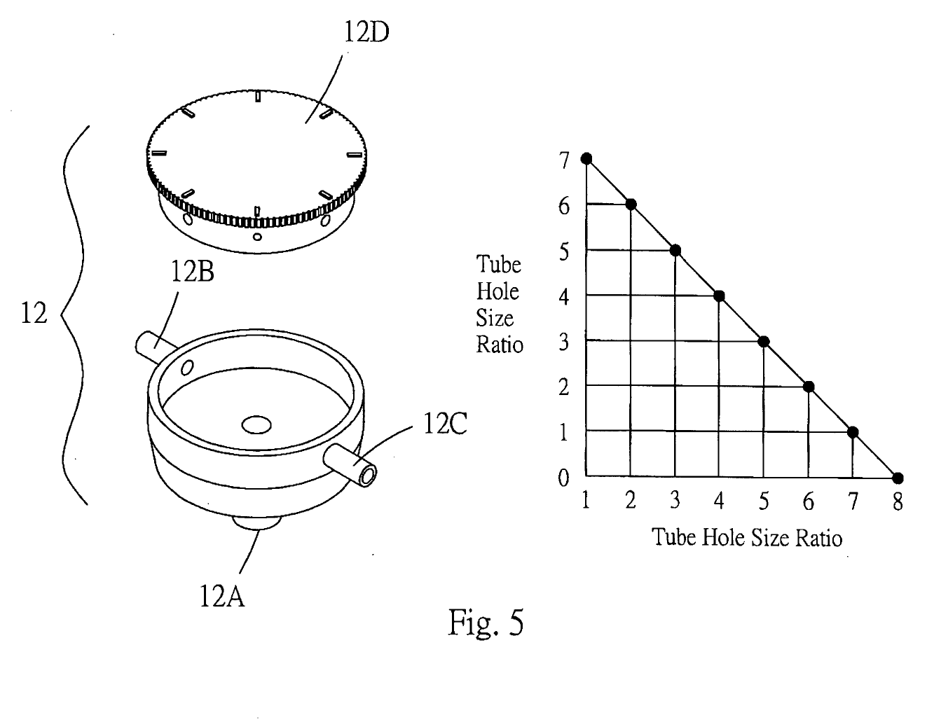

A magnetization assembly 10 includes at least one set of N pole magnetization unit 10B and S pole magnetization unit 10C. One side of each of the N pole magnetization unit 10B and S pole magnetization unit 10C has a water inlet 10A for filtering water. Referring to FIGS. 4 and 5, it is illustrated that the magnetization assembly 10 is formed by a stainless steel tube S. The stainless steel tube S is a hollow tube. An alloy toggle Q is installed in the tube. There are at least five high magnetic rare-earth permanent magnets 40, in that, opposite poles are faced to one another. Each space between two adjacent high magnetic rare-earth permanent magnets 40 has a pad 100 for isolating magnetic lines. All the high magnetic rar-e-earth permanent magnets 40 are divided into two rows which are spaced by a water channel 101 for guiding filtered water so that the water channel is retained with high magnetic field so that the magnetic lines from the high magnetic rare-earth permanent magnets 40 are repulsive to one another and are concentrated in the gaps therebetween. Furthermore the filtered water is magnetized by the high magnetic rare-earth permanent magnets 40. Another side of each of the N pole magnetization unit 10B and S pole magnetization unit 10C has a respective water outlet Nout, Sout. The filtered water flowing through the gaps are outputted from the water outlets to a respective transmission tube 11.

Each of the water outlets Nout, Sout is connected with a respective transmission tube 11. The transmission tube 11 contains nano-bamboo fibers having the functions of far infrared sterilization and deodorization. Furthermore the polarization water molecules from the water outlet of the magnetization assembly 10 are highly pure and sweet.

A dispatching control disk 12 has a tapered shape. An edge of the dispatching control disk 12 is formed with an N pole water inlet 12B and an S pole water inlet 12C. An apex of the tapered dispatching control disk 12 is formed with a common water outlet 12A. The dispatching control disk 12 is formed with a rotary disk 12D. The rotary disk 12D has eight holes of different sizes. A lower casing of the dispatching control disk 12 has the N pole water inlet 12B and S pole water inlet 12C. By coupling the dispatching control disk and the lower casing of the dispatching control disk so as to align the holes of the rotary disk rotary disk and the N pole water inlet and S pole water inlet of the lower casing, the micro-circulation water of different polarization ratio of N magnetization and S magnetization can be derived.

Referring to FIG. 5, the relativities of the hole sizes of the water from N pole water inlet 12B and S pole water inlet 12C are illustrated. The polarization water molecules of N polarization and S polarization are guided into the dispatching control disk 12 and then are mixed and then are outputted from the common water outlet 12A so as to form the micro-circulation water with different polarization ratio.

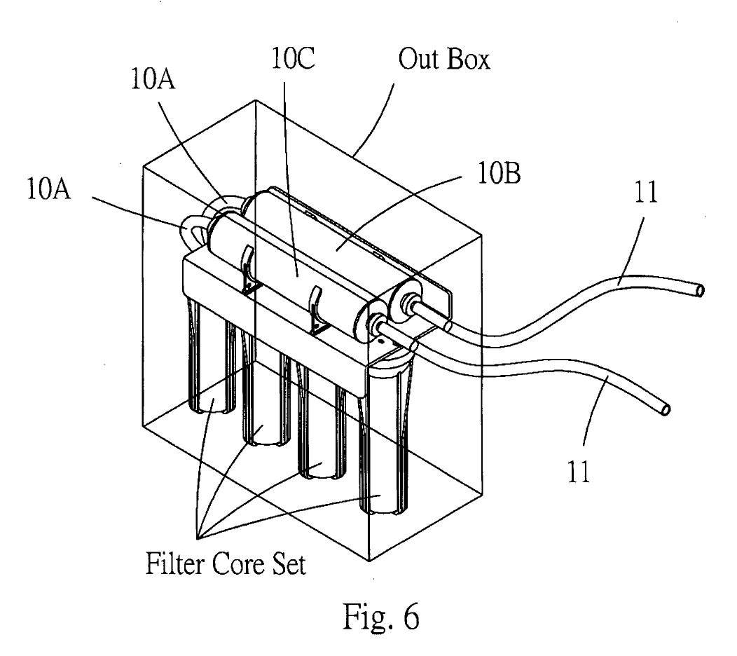

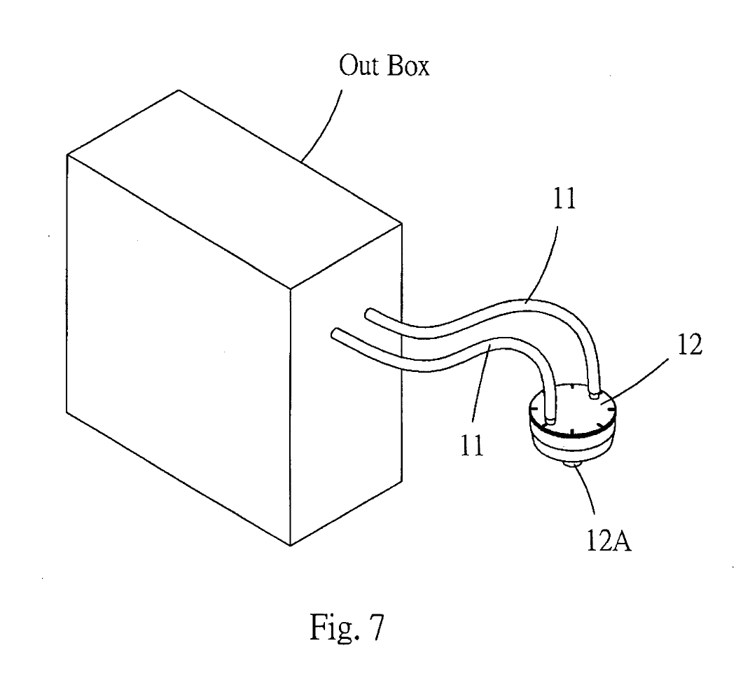

In the present invention, the water inlets 10A can be installed with filter core for removing chlorine, impurities, heavy metals, etc. The magnetization assembly 10 can be placed in a box, as shown in FIGS. 6 and 7. By above mentioned assembly, the N pole magnetization unit 10B and S pole magnetization unit 10C in the magnetization assembly 10 may generate pure magnetized water.

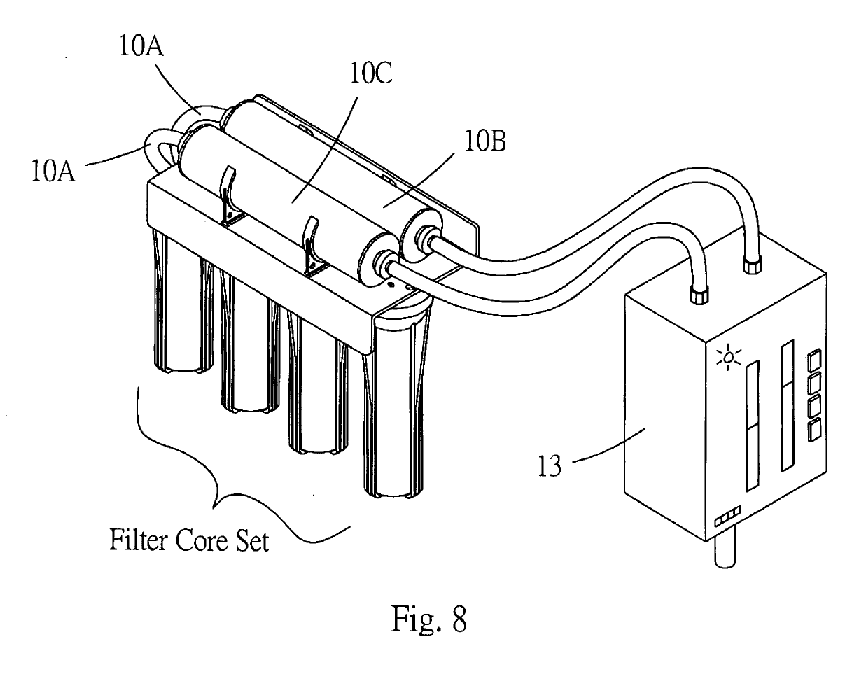

Referring to FIG. 8, another embodiment of the present invention is illustrated. The dispatching control disk 12 can be designed as an electronic flow dispatching unit 13 which comprises a circuit control module, a dual polarization flow stub, a mixing cylinder, and a water output control set. The stub is connected to the transmission tubes 11 from the N pole magnetization unit 10B and S pole magnetization unit 10C. The ratio of the water from the N pole magnetization unit 10B and S pole magnetization unit 10C are controlled by the circuit and then the water is mixed in the mixing cylinder so as to get high magnetic water.

Advantages of the present invention are that the micro-circulation polarization water is beneficial to human body. Moreover, the present invention can be assembled with different filters to have lower cost. Further the lifetime of the filter is prolonged.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A magnetic water generator with varied polarization ratios, comprising:
a magnetization assembly including at least one set of N pole magnetization unit and S pole magnetization unit; one side of each of the N pole magnetization unit and S pole magnetization unit having a water inlet for inputting filtering water; another side of each of the N pole magnetization unit and S pole magnetization unit having a respective water outlet; the filtered water flowing through the gaps being outputted from the water outlets to a respective transmission tube
each of the water outlets being connected with a respective transmission tube; and
a dispatching control disk having a tapered shape; an edge of the dispatching control disk being formed with an N pole water inlet and an S pole water inlet; the dispatching control disk being formed with a common water outlet; the dispatching control disk being formed with a rotary disk; the rotary disk having holes of different sizes; a lower casing of the dispatching control disk having the N pole water inlet and S pole water inlet; by coupling the dispatching control disk and the lower casing of the dispatching control disk so as to align the holes of the rotary disk rotary disk and the N pole water inlet and S pole water inlet of the lower casing, the micro-circulation water of different polarization ratio of N magnetization and S magnetization can be derived.

2. The magnetic water generator with varied polarization ratios as claimed in claim 1, wherein the magnetization assembly is formed by a stainless steel tube; the stainless steel tube is a hollow tube; an alloy toggle is installed in the tube; there are at least five high magnetic rare-earth permanent magnets, in that, opposite poles are faced to one another; each space between two adjacent high magnetic rare-earth permanent magnets has a pad for isolating magnetic lines; all the high magnetic rare-earth permanent magnets are divided into two rows which are spaced by a water channel for guiding filtered water so that the water channel is retained with high magnetic field so that the magnetic lines from the high magnetic rare-earth permanent magnets are repulsive to one another and are concentrated in the gaps therebetween; the filtered water is magnetized by the high magnetic rare-earth permanent magnets.

3. The magnetic water generator with varied polarization ratios as claimed in claim 1, wherein the transmission tube contains nano-bamboo fibers having the functions of far infrared sterilization and deodorization the polarization water molecules from the water outlet of the magnetization assembly are highly pure and sweet.

4. A magnetic water generator with varied polarization ratios, comprising:
a magnetization assembly including at least one set of N pole magnetization unit and S pole magnetization unit; one side of each of the N pole magnetization unit and S pole magnetization unit having a water inlet for inputting filtering water; another side of each of the N pole magnetization unit and S pole magnetization unit having a respective water outlet; the filtered water flowing through the gaps being outputted from the water outlets to a respective transmission tube;
each of the water outlets being connected with a respective transmission tube; and
an electronic flow dispatching unit including a circuit control module, a dual polarization flow stub, a mixing cylinder, and a water output control set; the stub being connected to the transmission tubes from the N pole magnetization unit and S pole magnetization unit; the ratio of the water from the N pole magnetization unit and S pole magnetization unit being controlled by the circuit and then the water being mixed in the mixing cylinder so as to get high magnetic water.
